(19) United States
(12) Patent Application Publication
(10) Pub. No.: US 2025/0272576 A1
(43) Pub. Date: Aug. 28, 2025

(54) METHOD AND/OR APPARATUS FOR ARCHITECTURE SEARCH

(71) Applicant: Robert Bosch GmbH, Stuttgart (DE)

(72) Inventors: Arber Zela, Bad Krotzingen (DE); Benedikt Sebastian Staffler, Tuebingen (DE); Frank Hutter, Freiburg Im Breisgau (DE); Mahmoud Safari, Freiburg Im Breisgau (DE); Rhea Sukthanker, Freiburg Im Breisgau (DE)

(21) Appl. No.: 19/057,512

(22) Filed: Feb. 19, 2025

(30) Foreign Application Priority Data
Feb. 26, 2024 (DE) 10 2024 201 758.2

(51) Int. Cl. G06N 3/0985

(52) U.S. Cl. CPC G06N 3/0985

(57) ABSTRACT

A method for an architecture search of architecture of a one-shot neural network in order to solve a multi-task problem depending on at least one piece of target hardware.

### CROSS REFERENCE

The present application claims the benefit under 35 U.S.C. § 119 of German Patent Application No. DE 10 2024 201 758.2 filed on Feb. 26, 2024, which is expressly incorporated herein by reference in its entirety.

### FIELD

The present invention relates to a method and/or to an apparatus for an architecture search of neural network architecture.

### BACKGROUND INFORMATION

Neural networks are increasingly being used in control units for vehicle and in other embedded systems to evaluate measured variables. In comparison with other evaluation techniques, neural networks are characterized by their great power of generalization. This means that, after sufficient training, they can correctly evaluate even previously unseen situations and generate control signals that lead to a reaction that is appropriate to the situation from the vehicle or other system.

The price for this performance is that neural networks place comparatively high demands on the hardware platform on which they are implemented. Typically, graphics processing units (GPUs) with large memory capacities are required. Apart from the fact that the price of the hardware platform increases with its features, space is often limited in control units for vehicles and other embedded systems. The maximum current consumption is also limited by the energy source used, such as the electrical system of a vehicle or a battery, and/or by the maximum permissible heat dissipation. Therefore, Germany Patent Application No. DE 10 2019 202 816 A1 describes a method for training a neural network in which less relevant neurons and connections between neurons are completely deactivated.

The applicant has also disclosed a method for multiple-criteria architecture search. The method was concerned with the search for a one-shot neural architecture for multi-objective optimization. In said method, a technique is proposed that allows a multi-objective optimization problem to be optimized without having to resort to a scalarization of the different objectives. Furthermore, this approach provides not only a single architecture for a particular weighting of the optimization objectives, but a series of optimal architectures for different weightings of the objectives. To achieve this, the method comprises the following steps: A sample weighting of the objectives from the Dirichlet distribution is carried out. Furthermore, a sample of architecture is taken from a distribution dependent on an objective weighting. Weights are updated to minimize a loss function or cost function, wherein the parameters of the one-shot network are adjusted. Architecture parameters are also adjusted to minimize the cost function.

### SUMMARY

It is an object of the present invention to specify an improved method and/or an improved apparatus for training a one-shot neural network.

The object of the present invention may be achieved by a method having certain features of the present invention. The object may also be achieved by an apparatus having certain features of the present invention.

### SUMMARY

According to a first aspect of the present invention, a method is specified for an architecture search of architecture of a one-shot neural network f(w,α) in order to solve a multi-task problem depending on at least one piece of target hardware D. According to an example embodiment of the present invention, the method comprises the following steps: providing a hypernetwork g having network parameters θ, task weights or sub-objective weights λ and at least one hardware embedding e_{hw} for the at least one piece of target hardware D; providing the one-shot neural network f(w,α) having network weights w and architecture parameters α; initializing the task weights λ; in particular randomly selecting, in particular by means of the hypernetwork g, the architecture parameters α depending on the initialized task weights λ and the at least one hardware embedding e_{hw} for each piece of target hardware d of the at least one piece of target hardware D; calculating a gradient g_{θ}^{d} relating to the network parameters θ by means of a loss function g_{θ}^{d}=∇_{θ}ΣᵢλᵢLᵢ(α,w); calculating a multiple-gradient descent g_{θ} for each piece of target hardware d of the at least one piece of target hardware D; updating the network parameters θ on the basis of the multiple-gradient descent g_{θ} and/or on the basis of the update of the task weights λ; calculating a gradient g_{w}^{d} relating to the network weights w by means of a loss function g_{w}^{d}=∇_{w}ΣᵢλᵢLᵢ(α,w); aggregating the calculated gradients g_{w}^{d}; and updating the network weights w on the basis of the aggregated gradients.

According to a second aspect of the present invention, an apparatus is specified for architecture search of the architecture of a one-shot neural network f(w,α) in order to solve a multi-task problem depending on at least one piece of target hardware D. According to an example embodiment of the present invention, the apparatus comprises an evaluation and computing device, which is designed to carry out the following steps: providing a hypernetwork g having network parameters θ, task weights λ and at least one hardware embedding e_{hw} for the at least one piece of target hardware D; providing the one-shot neural network f(w,α) having network weights w and architecture parameters α; initializing the task weights λ; in particular randomly selecting the architecture parameters α depending on the initialized task weights λ and the at least one hardware embedding e_{hw} for each piece of target hardware d of the at least one piece of target hardware D; calculating a gradient g_{θ}^{d} relating to the network parameters θ by means of a loss function g_{θ}^{d}=∇_{θ}ΣᵢλᵢLᵢ(α,w); calculating a multiple-gradient descent g_{θ} for each piece of target hardware d of the at least one piece of target hardware D; updating the network parameters θ on the basis of the multiple-gradient descent g_{θ} and/or on the basis of the update of the task weights λ; calculating a gradient g_{w}^{d} relating to the network weights w by means of a loss function g_{w}^{d}=∇_{w}ΣᵢλᵢLᵢ(α,w); aggregating the calculated gradients g_{w}^{d}; and updating the network weights w on the basis of the aggregated gradients.

The statements made for the method of the present invention apply accordingly to the apparatus of the present invention, and vice versa.

It is understood that the steps according to the present invention as well as other optional steps do not necessarily have to be carried out in the order shown, but can also be carried out in a different order. Other intermediate steps can also be provided. The individual steps can also comprise one or more sub-steps without departing from the scope of the method according to the present invention.

According to an example embodiment of the present invention, training the one-shot neural network f(w,α) is done by updating the network parameters θ and the network weights w, i.e., on the basis of the updated network weights w and the updated network parameters θ.

Particularly preferably, one or more meta-learned predictors for hardware objective functions are provided. The hardware objective functions are preferably optimized with respect to latency. The predictors are preferably trained before the architecture search and then used to compute objective functions for hardware. The predictors preferably use a hardware embedding, just like the function g, in order to be able to generalize to different hardware. The predictors are preferably trained using a simple procedure, in particular by sampling a piece of hardware and architecture in each training step. The task weights are preferably not trainable and are drawn from a probability distribution in each training iteration. The method and/or apparatus is concerned with the architecture search for a neural network architecture for multi-task approaches and/or for multiple-criteria approaches and/or for hardware-sensitive approaches.

In the context of the neural architecture search, a one-shot model preferably refers to a technique in which a single neural network is trained to represent and evaluate multiple candidate architectures simultaneously. Instead of training and evaluating each architecture individually, a one-shot model allows efficient exploration of a large search space by sharing weights and parameters across different architectures. The one-shot model consists of a supernetwork, which represents a larger network that comprises all possible architectures. It comprises various architectural components such as convolutional layers, pooling layers, and skip connections, which can be selectively enabled or disabled for each candidate architecture. By using different activation patterns, the supernetwork can simulate different architectures within a single model. During the training process, the one-shot model is trained on a proxy task such as image classification, wherein a combination of architectural parameters and weight distribution is used. The model learns to adjust its weights and parameters on the basis of the performance of different architectures within the supernetwork. This allows efficient exploration of the search space, since the model can evaluate multiple architectures simultaneously and update its parameters accordingly. Once training is complete, the one-shot model can select the best architecture on the basis of its learned weights and parameters. This selected architecture can then be retrained from scratch or fine-tuned to achieve optimal performance in the target application. Overall, the one-shot model approach in the neural architecture search allows efficient exploration of the search space by training a single model to represent and evaluate multiple candidate architectures simultaneously.

A hypernetwork is a type of neural network used to generate or influence the parameters of another neural network. A hypernetwork usually comprises a main network, called the “base network,” and a secondary network or “hypernetwork.” The base network can be, for example, a CNN (convolutional neural network) or an RNN (recurrent neural network) or, as in the present case, a one-shot network that is trained, for example, for multi-task of image classification or speech processing. The hypernetwork is used to generate or manipulate the weights or other parameters of the base network or one-shot model. This provides a flexible possibility of adjusting the structure and/or parameters of the one-shot network without having to retrain the entire network. This can be particularly useful when a network is to be adjusted or fine-tuned for tasks or data without requiring all of the training time and resources for retraining.

It is self-evident that the at least one image file may also be a video file. The statements made in this application apply accordingly to video files to be generated. A text-in-video generation algorithm is then preferably used here.

The method and/or apparatus according to the present invention can be used, for example, in the technical context of generic facial recognition and/or in the technical context of vehicle assistance systems and/or in the technical context of autonomous driving and/or in the technical context of computer vision and/or in the technical context of the quality monitoring of manufacturing components during automatic optical inspection and/or in the technical context of other technical fields in which image data are evaluated and/or categorized and/or classified.

Particularly preferably, according to an example embodiment of the present invention, the method and/or apparatus can be used in the analysis of data that are obtained by at least one (image) sensor. The at least one sensor can, for example, ascertain measured values of an environment in the form of sensor signals. Such sensor signals can be present, for example, as digital images and/or videos. The sensor can be, for example, a camera and/or a lidar sensor and/or an ultrasonic sensor. The present invention can thus be used, for example, for image and/or video and/or audio analysis downstream of the detection, and there to classify or segment the captured image data in order in particular to solve multi-task problems. In general, it can be any type of sensor data (including radar, lidar, ultrasound, etc.) and/or data from multiple sensors (e.g. multiple cameras) and/or data from combinations of sensors (e.g. camera, radar & lidar).

The present invention can in particular be used to classify the sensor data and/or to recognize the presence of objects in the sensor data and/or to perform semantic segmentation of the sensor data, e.g. in relation to traffic signs, road surfaces, pedestrians and/or vehicles. In the present case, anomalies in the classification and/or segmentation of input data, for example the sensor data, can also be ascertained. The method and/or apparatus can also be used to determine one or more continuous values, i.e., to carry out a regression analysis, e.g. with regard to a distance, a speed, and/or an acceleration. The method and/or apparatus can also be used to track an element, e.g. an object, in the input data. This is done, for example, on the basis of low-level features (e.g. edges or pixel attributes in images).

The method and/or apparatus of the present invention can also be used to calculate a control signal for controlling a technical system, such as a computer-controlled machine, e.g. a robotic system, a vehicle, a household appliance, a power tool, a manufacturing machine, a personal assistant or an access control system. It can also be a system for transmitting information, such as a monitoring system or a medical (imaging) system. In this case, the method and/or apparatus are used to analyze input data (e.g. scalar time series), in particular from a sensor, any sensor, and operate the technical system accordingly on the basis of the analysis.

In the present case, the method according to an example embodiment of the present invention, in particular the hypernetwork, is extended by adding a hardware embedding as an additional input to the network in order to allow the sampling of architectures of the one-shot network also for different hardware. In addition, an optional memory bank and an attention mechanism can be added to the neural network.

In the present case, according to an example embodiment of the present invention, a training strategy that takes into account multiple target hardware devices is also adjusted. First, the updates for θ are preferably calculated for multiple target hardware platforms or target hardware devices using multiple-gradient descent. Furthermore, the updates for the one-shot model weights w are preferably calculated on the basis of multiple architectures, namely on the basis of the different hardware embeddings considered by the hypernetwork g.

Thus, a meta-learned latency predictor is provided, which is trained by sampling architecture and a target device during each training step. The predictors are preferably used in addition to the hypernetwork. These are preferably trained separately before the actual architecture search, in particular therefore before the training procedure described. During the architecture search, the predictors are fixed and remain unchanged.

The present method makes it possible to train and/or test architectures within the one-shot network for different hardware, which can be used both during training and for unknown hardware embeddings.

According to an example embodiment of the present invention, the training method preferably optimizes the hypernetwork such that it can predict architectures for multiple pieces of target hardware, and a prediction for unknown hardware with zero shots is also possible. The proposed training method leads to better performance of the predictor and possibly also to lower resource consumption.

The presented method optimizes the architecture of neural networks with respect to multiple objectives (also called multi-objective optimization problem). These can include both objectives for the performance of a neural network on a particular task (e.g., object recognition from images) and objectives relating to the efficiency of architecture on a target hardware device. The method can be used in any system that uses neural networks.

The method and/or apparatus may also use the multi-objective search with respect to model performance (e.g., accuracy, etc.) and the hardware performance of the model (e.g., latency, FLOPS, power consumption, memory usage). For example, an additional loss term can be added to the loss function, wherein the additional loss term predicts the hardware performance depending on architecture parameters of the one-shot model and/or the hypermodel.

In the present case, according to an example embodiment of the present invention, the one-shot model f(w,α) is used, which represents a superposition of multiple neural network architectures in a single network, wherein w are the weights of the individual architectures of the network, and α are the architecture parameters that determine which of the architectures embedded in the one-shot model is active. α can be an output of a function or a probability distribution g with the parameters θ: α=g(θ). g is preferably represented by a neural network. The objective of the one-shot architecture search is preferably the optimization θ to minimize a loss

$${min}_{θ} L ( α , w ( λ ) ) + λ {L}_{hw} ( α ) , subject to {min}_{w ( λ )} {L}_{data}^{*} ( a , w \vert λ ) ,$$

In this case, w are the optimal layer parameters, which may be dependent on λ. The layer parameters w can preferably be optimized by optimizing another data-dependent loss. For example, the loss L(α,w) can be the loss in validation data. L_{data}*(α,w) can be the loss in the training data. Preferably, L(α,w)=L_{data}*(α,w) can be selected. Furthermore, there can in principle be more than two loss functions, i.e., more generally,

$${min}_{θ} {\sum }_{i} {λ}_{i} {L}_{i} ( α , w ) subject to {min}_{w} {L}_{data}^{*} ( a , w \vert λ ) .$$

In a preferred aspect of the present invention, initializing comprises a sample weighting of the task weights λ from a Dirichlet distribution Dir(β) on the basis of a concentration hyperparameter β.

The Dirichlet distribution is a family of multivariate probability distributions and is used in statistics for modeling proportions or probability distributions across categories. The distribution is characterized by a vector of positive real numbers that serve as concentration parameters. These parameters affect how strongly the weights are concentrated toward the corners or edges of the simplex (a multidimensional space in which the sum of the coordinates is equal to 1) represented by the Dirichlet distribution. In the context of the sample weighting, initializing the task weights from a Dirichlet distribution means that the initial distribution of weightings between different tasks is determined by the characteristics of the Dirichlet distribution, which are controlled by. A higher value of would result in a more even distribution of weights, meaning a less biased initialization, while a lower value promotes a greater concentration on fewer tasks, which can be potentially useful when some tasks are considered more important than others or when it is desired to optimize model performance with respect to specific tasks.

In a preferred aspect of the present invention, the method comprises providing a hardware predictor having architecture parameters α and at least one hardware embedding e_{hw}. In a preferred aspect, the hardware predictor is trained by drawing architecture and a piece of target hardware, in particular randomly, for example from a probability distribution or a Dirichlet distribution, in each gradient update step.

In a preferred aspect of the present invention, the concentration hyperparameter β is initialized as a vector of ones.

The initialization of β as a vector of ones leads to a uniform Dirichlet distribution. In a uniform Dirichlet distribution, all possible distributions of the categories (or tasks) are equally probable. This approach does not imply any a priori assumptions about the importance or distribution of the categories and thus represents an “uninformed” starting condition. The use of a vector of ones as an initialization value is easy to implement and understand. It provides a clear and neutral starting point for modeling, which can be particularly useful when no specific prior information about the data to be modeled is available. Although the initialization starts with a vector of ones, the parameters β and the associated task weights λ can be adjusted during the training process. This allows the model to learn from the data and optimize the weights accordingly on the basis of the observed performance or properties of the data. In multi-task learning scenarios or other contexts in which the Dirichlet distribution is used to control the initialization or adjustment of model parameters, the decision to choose a vector of ones as the initialization of β can influence the learning process by providing a neutral, unbiased basis for exploring different weightings.

In a preferred aspect of the present invention, the network parameters θ are updated by using a Frank-Wolfe routine or by averaging the gradients of the multiple-gradient descent.

Updating the task weights is a step to optimize the weights of the different tasks and improve the overall performance of the model. According to example embodiments of the present invention, two specific methods are highlighted for this updating: the Frank-Wolfe routine and the averaging of the gradients of the multiple-gradient descent. The Frank-Wolfe routine, also known as the conditioned gradient method, is an optimization algorithm used for convex optimization problems. In contrast to other gradient descent methods that take steps toward the negative gradient of the objective function, the Frank-Wolfe routine searches for a solution within a convex solution space by solving a linear subproblem in each iteration step. This approach is particularly useful for optimization problems in which the solution must stay within a certain range or space, such as optimizing task weights that must satisfy certain constraints. The averaging of the gradients of the multiple-gradient descent is an approach typically applied in multi-task learning scenarios, where multiple tasks are learned simultaneously. This method takes into account the gradients of all tasks and averages them to find a common direction for updating the weights. This technique aims to find a compromise between the different tasks and determine an update direction that is advantageous overall for all the tasks. The Frank-Wolfe routine relates to how the gradients are aggregated with respect to the θ parameters. The θ parameters are then updated on the basis of the descent direction calculated using the Frank-Wolfe routine and using any optimizer (gradient descent+momentum, Adam, . . . ).

In a preferred aspect of the present invention, aggregation is carried out by averaging

$${g}_{w} = \frac{1}{\vert D \vert} {\sum }_{d ∈ D} {g}_{w}^{d} .$$

Other methods of aggregation may also be advantageous.

In a preferred aspect of the present invention, selecting the architecture parameters α comprises an output of a function or a probability distribution and/or the selection by the hypernetwork. In a preferred aspect of the present invention, the architecture parameters α are provided by means of the function g (or the hypernetwork) in a differentiable manner. For the use of discrete architecture parameters α, this can be done by using differentiable approximations such as the Straight-Through Gumbel-Softmax.

If the selection of architecture parameters α is based on the output of a function, it means that a specific mathematical or algorithmic function is used to determine the optimal or appropriate values for α. This function can be based on heuristics, optimization methods, or on performance metrics of the model on a validation dataset. The function evaluates potential architectures or configurations and selects the one that performs best according to a given criterion. If the selection is based on a probability distribution, this implies a probabilistic approach to determining α. Instead of directly determining fixed values, the architecture parameters are treated as random variables that follow certain distributions.

This method can be applied, for example, in the context of Bayesian optimization strategies, where the probability distribution represents the uncertainty about the model performance over the space of the possible architectures. The selection is then made in a way that iteratively reduces this uncertainty by selecting new data points (model architectures) that maximize the expected information gain.

In a preferred aspect of the present invention, an inference method is provided, comprising: using a one-shot neural network f(w,α) trained according to the present method in one of its aspects in order to solve a multi-task problem, in particular a classification task and/or a segmentation task.

Multi-task problems refer to scenarios in which a model is to solve multiple tasks simultaneously. This can increase the efficiency of the learning process and improve the generalization ability of the model, since it learns to extract features that are useful across different tasks.

Classification tasks are those in which the objective is to sort inputs into predefined categories. Segmentation tasks are those that aim to identify and classify specific ranges within the input data, often in the context of images, where the objective is, for example, to recognize different objects within an image and determine their boundaries. The proposed inference method utilizes the trained one-shot network to solve these multi-task problems effectively. By using the one-shot network, the learned weights and architecture parameters are used to manage new instances of the tasks with minimal training data.

In a preferred aspect, the present invention also provides a computer program having program code to carry out at least parts of the method according to the present invention in one of its embodiments when the computer program is executed on a computer. In other words, a computer program (product) comprising commands that, when the program is executed by a computer, cause the computer to carry out the method/steps of the method according to the present invention in one of its embodiments.

In a preferred aspect, the present invention also provides a computer-readable data carrier having program code of a computer program to carry out at least parts of the method according to the present invention in one of its embodiments when the computer program is executed on a computer. In other words, the present invention relates to a computer-readable (memory) medium comprising commands that, when executed by a computer, cause the computer to perform the method/steps of the method according to the present invention in one of its embodiments.

The described embodiments and developments of the present invention can be combined with one another as desired.

Further possible embodiments, developments and implementations of the present invention also include combinations not explicitly mentioned of features of the present invention described above or in the following relating to exemplary embodiments of the present invention.

### BRIEF DESCRIPTION OF THE DRAWINGS

The figures are intended to impart further understanding of example embodiments of the present invention. They illustrate embodiments and, in connection with the description, serve to explain principles and concepts of the present invention.

Other embodiments and many of the mentioned advantages are apparent from the figures. The illustrated elements of the figures are not necessarily shown to scale relative to one another.

FIG. 1 is a schematic flow chart of a method according to an example embodiment of the present invention.

FIG. 2 is a schematic block diagram of the method according to an example embodiment of the present invention.

In the figures, identical reference signs denote identical or functionally identical elements, parts or components, unless stated otherwise.

### DETAILED DESCRIPTION OF EXAMPLE EMBODIMENTS

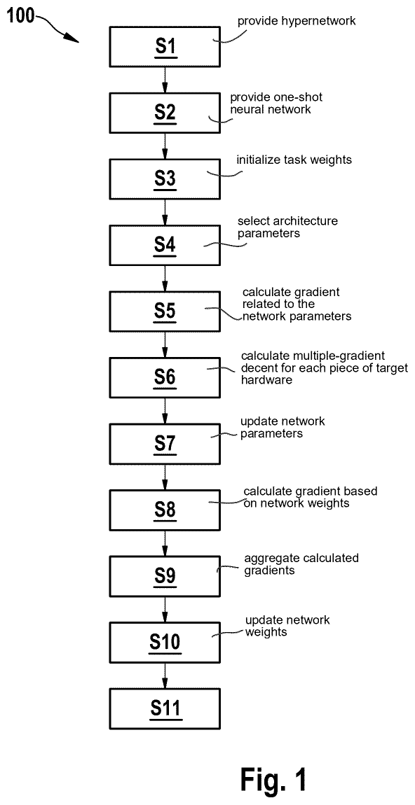

FIG. 1 shows a schematic flow chart of a method for training a one-shot neural network f(w,α) to solve a multi-task problem depending on at least one piece of target hardware D.

In any embodiment, the method can be carried out at least partially by an apparatus 100 that can comprise, for this purpose, multiple components (not represented in detail), for example one or more provision devices and/or at least one evaluating and computing device. It is self-evident that the provisioning device can be designed together with the evaluation and computing device, or can be different therefrom. Further, the apparatus can comprise a storage device and/or an output device and/or a display device and/or an input device.

The computer-implemented method comprises at least the following steps:

In a step S1, a hypernetwork g is provided, having network parameters θ, task weights λ and at least one hardware embedding e_{hw} for the at least one piece of target hardware D.

In a step S2, the one-shot neural network f(w,α) is provided, having network weights w and architecture parameters α.

In a step S3, the task weights λ are initialized. The initialization comprises a sample weighting of the task weights λ from a Dirichlet distribution Dir(β) on the basis of a concentration hyperparameter β. The concentration hyperparameter β is initialized as a vector of ones.

In a step S4, the architecture parameters α are selected, in particular randomly, depending on the initialized task weights λ and the at least one hardware embedding e_{hw} for each piece of target hardware d of the at least one piece of target hardware D. Selecting the architecture parameters α comprises an output of a function or a probability distribution. The selected architecture parameters α are preferably differentiable.

In a step S5, a gradient g_{θ}^{d} relating to the network parameters θ is calculated by means of a loss function g_{θ}^{d}=∇_{θ}ΣᵢλᵢLᵢ(α,w).

In a step S6, a multiple-gradient descent g_{θ} is calculated for each piece of target hardware d of the at least one piece of target hardware D. The calculation is done by using a Frank-Wolfe routine or by averaging the gradients of the multiple-gradient descent.

In a step S7, the network parameters θ are updated on the basis of the multiple-gradient descent g_{θ} and/or on the basis of the task weights λ.

In a step S8, a gradient g_{w}^{d} relating to the network weights w is calculated by means of a loss function g_{w}^{d}=∇_{w}ΣᵢλᵢLᵢ(α,w).

In a step S9, the calculated gradients g_{w}^{d} are aggregated. Aggregation is carried out by averaging

$${g}_{w} = \frac{1}{\vert D \vert} {\sum }_{d ∈ D} {g}_{w}^{d} .$$

In a step S10, the network weights w are updated on the basis of the aggregated gradients.

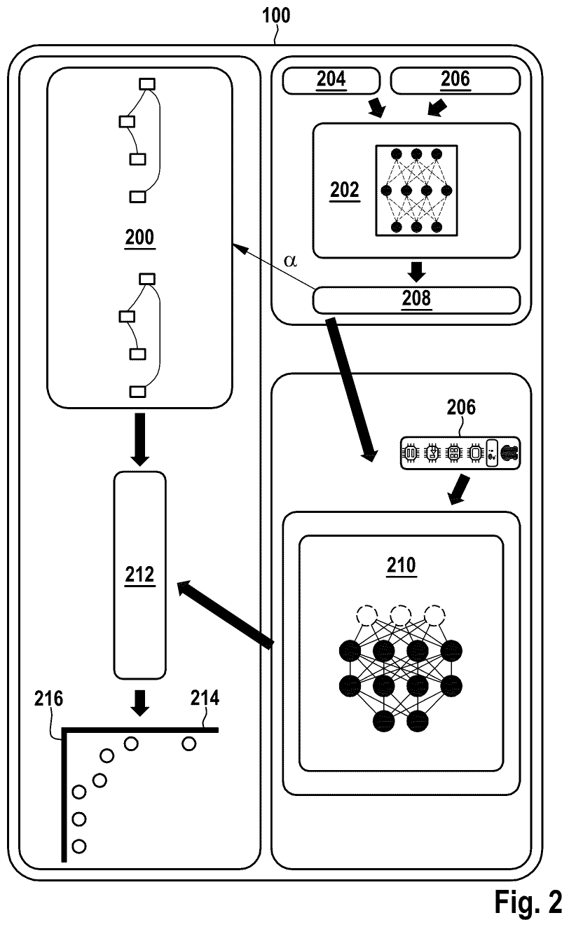

FIG. 2 shows a block diagram of an exemplary embodiment of the present method.

A one-shot neural network 200 is initialized by parameters of a hypernetwork 202. The hypernetwork 202 can also be a metanetwork. The hypernetwork 202 has network parameters θ. The hypernetwork 202 receives task weights 204, λ and at least one hardware embedding 206, e_{hw} as inputs. The architecture parameters α can be selected randomly depending on the initialized task weights 204, λ and the at least one hardware embedding 206, e_{hw} for each piece of target hardware d of the at least one piece of target hardware D, which is indicated in FIG. 2 by the reference sign 208.

The outputs of the hypernetwork 202 can also serve as input to a predictor 210, which also receives the hardware embedding(s) 206 as input. The predictor 210 can be an MLP (multilayer perceptron) or a GCN (graph convolutional network). The predictor 210 can be pre-trained and frozen in this pre-trained state. The output of the predictor 210 can serve as input for a loss function 212, which also receives an output from the one-shot network 200, which was formed on the basis of the at least one architecture parameter α. The results of the loss function are plotted in a graph that plots an error 214 (abscissa) over a latency 216 (ordinate). Latency is just one example of a hardware metric here. Another example of a hardware metric is energy consumption.

The method can be illustrated again by way of example by the following mathematical formulation:

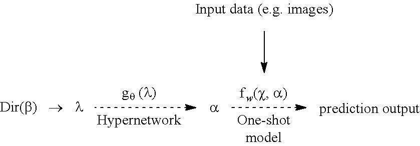

What is claimed is:

1. A method for an architecture search of architecture of a one-shot neural network f(w,α) in order to solve a multi-task problem depending on at least one piece of target hardware, the method comprising the following steps
providing a hypernetwork g having network parameters θ, task weights λ, and at least one hardware embedding e_{hw} for the at least one piece of target hardware D;
providing the one-shot neural network f(w,α) having network weights w and architecture parameters α;
initializing the task weights λ;
randomly selecting the architecture parameters α depending on the initialized task weights λ and the at least one hardware embedding e_{hw} for each piece of target hardware d of the at least one piece of target hardware D;
calculating a gradient g_{θ}^{d} relating to the network parameters θ using a loss function g_{θ}^{d}=∇_{θ}ΣᵢλᵢLᵢ(α,w);
calculating a multiple-gradient descent g_{θ} for each piece of target hardware d of the at least one piece of target hardware D;
updating the network parameters θ based on the multiple-gradient descent g_{θ} and/or based on an update of the task weights λ;
calculating a gradient g_{w}^{d} relating to the network weights w using a loss function g_{w}^{d}=∇_{w}ΣᵢλᵢLᵢ(α,w);
aggregating the calculated gradients g_{w}^{d}; and
updating the network weights w based on the aggregated gradients.

2. The method according to claim 1, wherein initializing includes a sample weighting of the task weights λ from a Dirichlet distribution Dir(β) based on a concentration hyperparameter β.

3. The method according to claim 2, wherein the concentration hyperparameter β is initialized as a vector of ones.

4. The method according to claim 1, wherein the network parameters θ are updated by using a Frank-Wolfe routine or by averaging gradients of the multiple-gradient descent.

5. The method according to claim 1, wherein aggregation is carried out by averaging
$${g}_{w} = \frac{1}{\vert D \vert} {\sum }_{d ∈ D} {g}_{w}^{d} .$$

6. The method according to claim 1, wherein the selecting of the architecture parameters α includes: (i) an output of a function or a probability distribution and/or (ii) the selection by the hypernetwork.

7. An inference method, comprising:
using a trained one-shot neural network f(w,α) to solve a multi-task problem, the multi-task program including a classification task and/or a segmentation task, the one-shot neural network f(w,α) being trained by:
providing a hypernetwork g having network parameters θ, task weights λ, and at least one hardware embedding e_{hw} for the at least one piece of target hardware D,
providing the one-shot neural network f(w,α), the one-shot neural network having network weights w and architecture parameters α,
initializing the task weights λ,
randomly selecting the architecture parameters α depending on the initialized task weights λ and the at least one hardware embedding e_{hw} for each piece of target hardware d of the at least one piece of target hardware D,
calculating a gradient g_{θ}^{d} relating to the network parameters θ using a loss function g_{θ}^{d}=∇_{θ}ΣᵢλᵢLᵢ(α,w),
calculating a multiple-gradient descent g_{θ} for each piece of target hardware d of the at least one piece of target hardware D,
updating the network parameters θ based on the multiple-gradient descent g_{θ} and/or based on an update of the task weights λ,
calculating a gradient g_{w}^{d} relating to the network weights w using a loss function g_{w}^{d}=∇_{w}ΣᵢλᵢLᵢ(α,w),
aggregating the calculated gradients g_{w}^{d}, and
updating the network weights w based on the aggregated gradients.

8. A non-transitory computer-readable data carrier on which is stored program code of a computer program for an architecture search of architecture of a one-shot neural network f(w,α) in order to solve a multi-task problem depending on at least one piece of target hardware, the program code, when executed by a computer, causing the computer to perform the following steps:
providing a hypernetwork g having network parameters θ, task weights λ, and at least one hardware embedding e_{hw} for the at least one piece of target hardware D;
providing the one-shot neural network f(w,α) having network weights w and architecture parameters α;
initializing the task weights λ;
randomly selecting the architecture parameters α depending on the initialized task weights λ and the at least one hardware embedding e_{hw} for each piece of target hardware d of the at least one piece of target hardware D;
calculating a gradient g_{θ}^{d} relating to the network parameters θ using a loss function g_{θ}^{d}=∇_{θ}ΣᵢλᵢLᵢ(α,w);
calculating a multiple-gradient descent g_{θ} for each piece of target hardware d of the at least one piece of target hardware D;
updating the network parameters θ based on the multiple-gradient descent g_{θ} and/or based on an update of the task weights λ;
calculating a gradient g_{w}^{d} relating to the network weights w using a loss function g_{w}^{d}=∇_{w}ΣᵢλᵢLᵢ(α,w);
aggregating the calculated gradients g_{w}^{d}; and
updating the network weights w based on the aggregated gradients.

9. An apparatus configured for an architecture search of architecture of a one-shot neural network f(w,α) in order to solve a multi-task problem depending on at least one piece of target hardware D, the apparatus comprising:
an evaluation and computing device, configured to:
provide a hypernetwork g having network parameters θ, task weights λ, and at least one hardware embedding e_{hw} for the at least one piece of target hardware D,
provide the one-shot neural network f(w,α) having network weights w and architecture parameters α,
initialize the task weights λ;
randomly select the architecture parameters α depending on the initialized task weights λ and the at least one hardware embedding e_{hw} for each piece of target hardware d of the at least one piece of target hardware D,
calculate a gradient g_{θ}^{d} relating to the network parameters θ using a loss function g_{θ}^{d}=∇_{θ}ΣᵢλᵢLᵢ(α,w),
calculate a multiple-gradient descent g_{θ} for each piece of target hardware d of the at least one piece of target hardware D,
update the network parameters θ based on the multiple-gradient descent g_{θ} and/or based on an update of the task weights λ,
calculating a gradient g_{w}^{d} relating to the network weights w using a loss function g_{w}^{d}=∇_{w}ΣᵢλᵢLᵢ(α,w),
aggregating the calculated gradients g_{w}^{d}, and
updating the network weights w based on the aggregated gradients.
